(19) United States
(12) Patent Application Publication
(10) Pub. No.: US 2011/0103939 A1
(43) Pub. Date: May 5, 2011

(54) TURBINE ROTOR BLADE TIP AND SHROUD CLEARANCE CONTROL

(75) Inventors: Hua Zhang, Greer, SC (US); Yang Liu, Simpsonville, SC (US)

(73) Assignee: GENERAL ELECTRIC COMPANY, Schenectady, NY (US)

(21) Appl. No.: 12/609,201

(22) Filed: Oct. 30, 2009

(51) Int. Cl. F01D 11/18; F02C 7/12

(52) U.S. Cl. 415/173.2; 415/177

(57) ABSTRACT

A gas turbine engine includes a turbine shell that is configured to retain a turbine rotor shroud adjacent to a turbine rotor blade. A heat pipe has a first end in thermal communication with the turbine shell and a second end extending outwardly of the shell. A heating/cooling system is in thermal communication with the second end of the heat pipe and has a thermal medium configurable to exchange thermal energy with the second end of the heat pipe. The thermal medium is configurable to remove thermal energy from the second end of the heat pipe to remove thermal energy from the turbine shell and is configurable to add thermal energy to the second end of the heat pipe to add thermal energy to the turbine shell.

### BACKGROUND OF THE INVENTION

The subject matter disclosed herein relates to gas turbine engines and, more particularly to turbines having inner and outer turbine shells configured to afford active turbine rotor blade tip and shroud clearance control.

In gas turbine engines the stationary hot gas path turbine engine components such as the turbine nozzles and turbine blade shrouds may be attached to turbine shell structures having large thermal mass. As a result the turbine blade shrouds are susceptible to turbine blade clearance issues (both positive and negative) as the turbine shell thermally distorts. More specifically, turbine blade to shroud clearance is subject to the thermal characteristics of the turbine as exhibited by thermal growth or shrinkage of the turbine shell during steady state and transient operations. Turbine blade to shroud clearance, particularly in heavy-duty industrial gas turbines, is typically determined by the maximum closure between the shrouds and the turbine blade tips, which usually occurs during a temperature transient.

Turbine blade tip to shroud clearance is a primary contributor to improved thermodynamic performance of the gas turbine engine. Turbine shell distortion caused by thermal loads manifests itself as a variation in radial location of the turbine blade shrouds. Such variation may be accounted for by increased turbine blade tip to shroud operating clearances as noted. However, such an adjustment may have a negative impact on the thermodynamic performance of the turbine engine.

Hot gas path components in gas turbine engines may employ air convection and air film techniques for cooling surfaces exposed to high exhaust gas temperatures. High-pressure air is diverted from the turbine engine compressor resulting in efficiency losses in the gas turbine engine. Steam cooling of hot gas path components uses available steam from, for example, an associated heat recovery steam generator and/or steam turbine of a combined cycle power plant. There is typically a net efficiency gain with the use of steam cooling inasmuch as the gains realized by not extracting compressor bleed air more than offset the losses associated with the use of steam as a coolant instead of providing energy to drive the steam turbine.

Consequently, there is a need to reduce the variation in radial clearance between the turbine blade tips and shrouds, while also reducing or eliminating the use of compressor air or power plant steam, thereby improving the efficiency of the gas turbine engine and related components.

### BRIEF DESCRIPTION OF THE INVENTION

According to one aspect of the invention, a turbine shell is configured to retain a turbine rotor shroud adjacent to a turbine rotor blade. A heat pipe has a first end in thermal communication with the turbine shell and a second end extending outwardly of the shell. A heating/cooling system is in thermal communication with the second end of the heat pipe and has a thermal medium configurable to exchange thermal energy with the second end of the heat pipe. The thermal medium is configurable to remove thermal energy from the second end of the heat pipe to remove thermal energy from the turbine shell and is configurable to add thermal energy to the second end of the heat pipe to add thermal energy to the turbine shell.

According to another aspect of the invention, a gas turbine engine comprises a turbine having a rotor configured for rotation about a shaft, a turbine rotor blade extending radially outwardly from the rotor to terminate adjacent to a turbine rotor shroud and a turbine shell configured to retain the turbine rotor shroud adjacent to the turbine rotor blade. A heat pipe has a first end in thermal communication with the turbine shell and a second end extending outwardly of the shell. A heating/cooling system is in thermal communication with the second end of the heat pipe and has a thermal medium that is configurable to exchange thermal energy with the second end of the heat pipe to remove thermal energy from the second end of the heat pipe and to add thermal energy to the second end of the heat pipe.

According to yet another aspect of the invention, a gas turbine engine comprises a turbine having a rotor configured for rotation about a shaft, a turbine rotor blade extending radially outwardly from the rotor to terminate adjacent to a turbine rotor shroud, an inner shell configured to retain the turbine rotor shroud adjacent to the turbine rotor blade and an outer shell configured to support the inner shell. A heat pipe has a first end in thermal communication with the turbine shell and a second end extending outwardly of the shell. A heating/cooling system is in thermal communication with the second end of the heat pipe and has a thermal medium that is configurable to exchange thermal energy with the second end of the heat pipe to remove thermal energy from the second end of the heat pipe and to add thermal energy to the second end of the heat pipe.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an axial sectional view through a portion of an exemplary gas turbine engine in accordance with an embodiment of the invention;

FIG. 2 is an enlarged sectional view through a portion of the gas turbine engine of FIG. 1;

FIG. 3 is a schematic, cross sectional view of an embodiment of a heat pipe of the gas turbine engine of FIG. 1, in one mode of operation;

FIG. 4 is a schematic, cross sectional view of the embodiment of a heat pipe, shown in FIG. 3, in another mode of operation;

FIG. 5 is a schematic, cross sectional view of another embodiment of a heat pipe of the gas turbine engine of FIG. 1, in one mode of operation; and

FIG. 6 is a schematic, cross sectional view of the embodiment of a heat pipe, shown in FIG. 5, in another mode of operation.

The detailed description explains embodiments of the invention, together with advantages and features, by way of example with reference to the drawings.

### DETAILED DESCRIPTION OF THE INVENTION

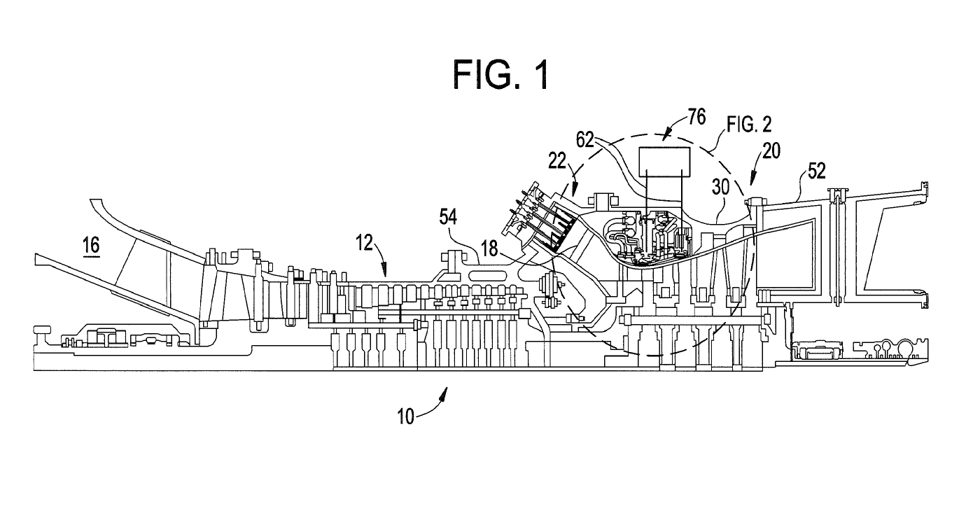

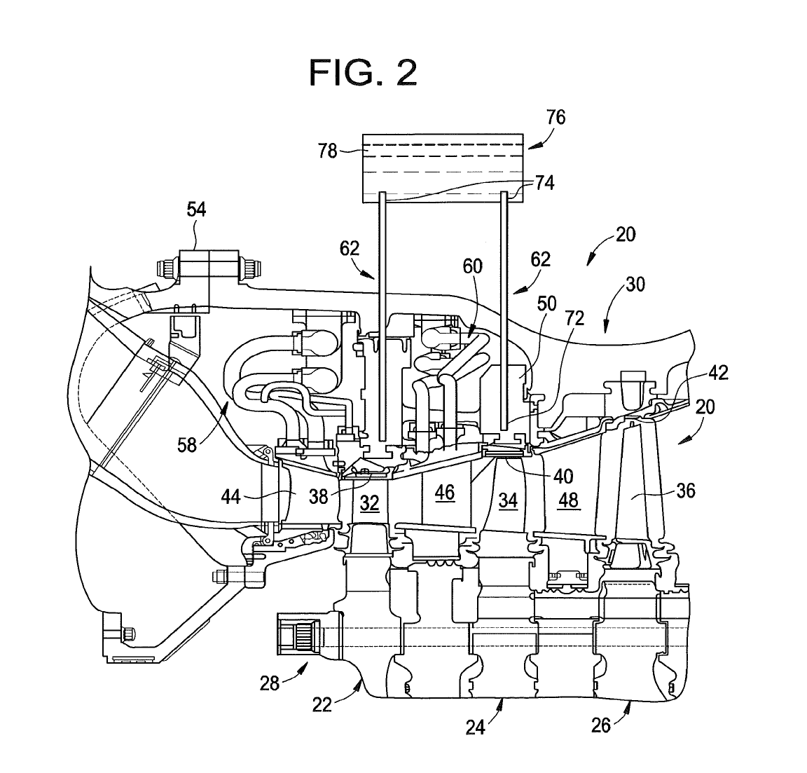

Illustrated in FIGS. 1 and 2 is a portion of a gas turbine engine 10. The engine is axisymetrical about a longitudinal, or axial centerline axis and includes a multi-stage axial flow compressor 12. Air enters the inlet of the compressor at 16, is compressed by the axial flow compressor 12 and is then discharged to a combustor 18 where fuel, such as natural gas, is combusted with the compressed air to provide high temperature combustion gas to drive a turbine 20. In the turbine 20, the energy of the hot combustion gas is converted into work, some of which is used to drive the compressor 12. The remainder of the available energy in the hot combustion gas is available for useful work to drive, for example, a load such as a generator (not shown), for production of electricity.

Following combustion, the hot combustion gas drives the turbine section 20 which, in one embodiment, may include three or more successive stages represented by three rotor assemblies 22, 24 and 26 comprising the turbine rotor 28 and mounted for rotation within a turbine housing 30. Each rotor assembly carries a row of turbine rotor blades 32, 34 and 36 which extend radially outwardly from the turbine rotor 28 to terminate adjacent turbine rotor blade shrouds 38, 40 and 42. The turbine rotor blades 32, 34 and 36 of the rotor assemblies 22, 24 and 26 are arranged alternately between fixed nozzle assemblies represented by turbine nozzle vanes 44, 46 and 48, respectively. As such, three stages of a multi-stage turbine 20 are illustrated wherein the first stage comprises nozzle vanes 44 and turbine rotor blades 32; the second stage comprises nozzle vanes 46 and turbine rotor blades 34; and the third stage comprises nozzle vanes 48 and turbine rotor blades 36. Additional stages may be used in the turbine and will typically depend on the application of the gas turbine engine 10.

In the embodiment shown the turbine includes an outer structural containment shell or turbine housing 30 and an inner shell 50. Inner shell 50 is configured to support turbine rotor blade shrouds 38 and 40 associated with the first and second stages. The outer shell 70 is typically secured at axially opposite ends to the turbine exhaust frame 52, FIG. 1, and at its upstream end to the compressor discharge casing 54. In one non-limiting embodiment, the outer and inner shells 50 and 30 may each comprise shell sections such as arcuate shell halves, that extend 180 degrees for each shell half about the axis of turbine rotor 28. It will be appreciated that the inner shell sections, as well as the outer shell sections, may be formed of integral castings or fabrications that are responsive to temperature changes and, as such, expand or contract depending upon those temperature changes.

The axial extent of the turbine inner shell 50 may be from one, to all turbine stages. As illustrated in FIG. 2, the inner shell 50 includes the first two of the illustrated turbine stages and, in particular, two stages of stationary turbine rotor blade shrouds 38 and 40 that are attached thereto. The inner shell 50 is attached to the outer shell 30 along radial planes that may be normal to the axis of the turbine rotor 28 and at axial locations which are typically in alignment with the first and second stage turbine rotor blades 32, 34 and shrouds 38, 40 thereby enabling movement of the shell 50 in a radial direction as a result of thermal distortion.

In an exemplary embodiment, disposed between the outer shell 30 and the inner shell 50 are steam cooling assemblies 58 and 60 that are configured to circulate cooling steam through the first and second stage turbine nozzle vanes 44 and 46, respectively. The steam operates to cool the turbine nozzle vanes 44 and 46 during operation of the gas turbine engine 10.

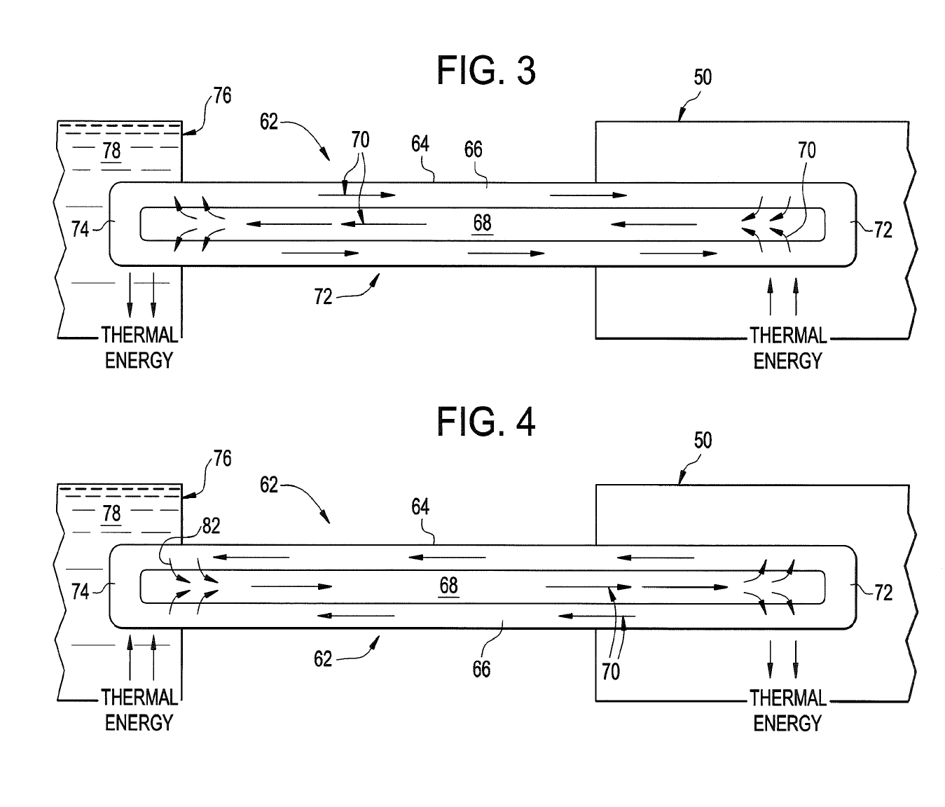

In an exemplary embodiment, the inner shell 50 carries a series of heat pipes 62 (shown schematically) that may be located at spaced intervals, both axially and circumferentially, about the circumference of the shell 50. In an exemplary embodiment of a heat pipe 62, shown in FIGS. 3 and 4, each heat pipe includes a casing 64 defining an outer surface of the heat pipe. Disposed internally of the casing 64 is an absorbent wick 66 that surrounds a vapor cavity 68. A heat transfer medium 70, such as water or sodium or other suitable material, is disposed within the vapor cavity 68. A first end 72 of the heat pipe is disposed within the inner shell 50 of the turbine 20 and a second end 74 of the heat pipe 62 extends outwardly from the inner shell 50 and is associated with a heating/cooling system 76 that operates with a thermal medium 78 to remove thermal energy from the second end 74 of the heat pipe 62 under certain conditions (FIG. 3) and to add thermal energy to the second end 74 of the heat pipe 62 under other conditions (FIG. 4), to be described in further detail below.

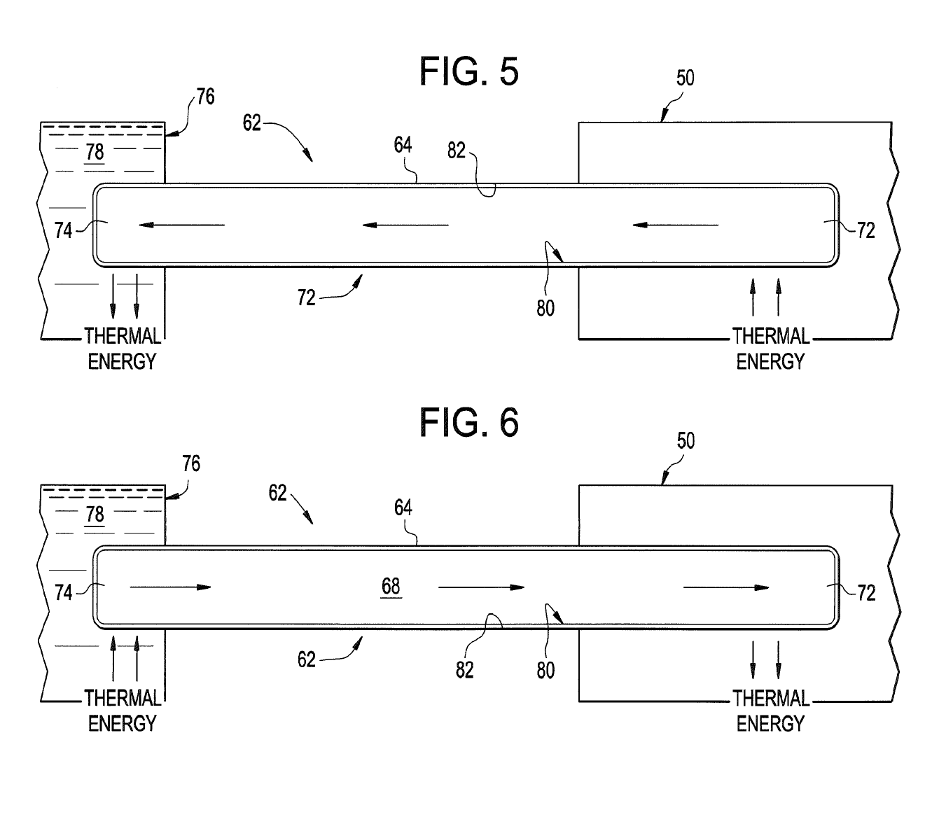

In another exemplary embodiment shown in FIGS. 5 and 6, the heat pipe 62 may be of a solid state construction in which the thermal energy is absorbed by a highly thermally conductive, inorganic solid heat transfer medium 80 disposed on the inner wall 82 of the heat pipe casing 64 (ex. a solid state, superconducting heat pipe). In an exemplary embodiment, a heat transfer medium 80 is applied to the inner wall 82 in three basic layers. The first two layers are prepared from solutions which are exposed to the inner wall 82 of the casing 64. Initially the first layer which primarily comprises, in ionic form, various combinations of sodium, beryllium, a metal such as manganese or aluminum, calcium, boron, and a dichromate radical, is absorbed into the inner wall 82 of the casing 64 to a depth of 0.008 mm to 0.012 mm. Subsequently, the second layer which primarily comprises, in ionic form, various combinations of cobalt, manganese, beryllium, strontium, rhodium, copper, B-titanium, potassium, boron, calcium, a metal such as aluminum and the dichromate radical, builds on top of the first layer and forms a film having a thickness of 0.008 mm to 0.012 mm over the inner wall 82 of the casing 64. Finally, the third layer is a powder comprising various combinations of rhodium oxide, potassium dichromate, radium oxide, sodium dichromate, silver dichromate, monocrystalline silicon, beryllium oxide, strontium chromate, boron oxide, B-titanium and a metal dichromate, such as manganese dichromate or aluminum dichromate, which evenly distributes itself across the inner wall 82. The three layers are applied to interior of the heat pipe casing 64 and are then heat polarized to form a superconducting heat pipe 62 that transfers thermal energy with little or no net heat loss. The process used to construct the heat pipe 62 may be any suitable method such as, for instance, the method described in U.S. Pat. No. 6,132,823, issued Oct. 17, 2000 and entitled Superconducting Heat Transfer Medium.

The inorganic compounds utilized in such an application are typically unstable in air, but have high thermal conductivity in a vacuum. Thermal energy migrates, via the solid heat transfer medium 80, from a high temperature end to a low temperature end of the heat pipe 62 via the solid heat transfer medium.

FIGS. 3 and 5 illustrate the application of a heat pipe 62 in a cooling mode during which thermal energy is removed from the inner shell 50 of the turbine 20. In a cooling mode, the first end 72 of the heat pipe is at a higher temperature than the second end 74 of the heat pipe that is in communication with the heating/cooling system 76. Such a circumstance may, for instance occur during steady-state operating conditions of the gas turbine engine 10 when it is desired to remove heat from the inner shell 50 to help maintain desired steady state temperatures within the turbine stages. Thermal energy from the inner shell 50 is transferred to the first end 72 of the heat pipe inducing heat transfer to the second end 74, which is maintained at a lower temperature by the heating/cooling system 76 where thermal energy is to the heating/cooling system 76.

FIGS. 4 and 6 illustrate the application of a heat pipe 62 in a heating mode during which thermal energy is added to the inner shell 50. In a heating mode, the heating/cooling 76 system delivers thermal energy to the second end 74 of the heat pipe such that it is at a higher temperature than the first end 72 of the heat pipe which is in communication with the inner shell 50. Such a circumstance may, for instance occur during transient operating conditions of the gas turbine engine 10 when it is desired to add heat to the inner shell 50 to help maintain desired clearance between the tips of the turbine rotor blades 32 and 34 and the turbine rotor blade shrouds 38 and 40 during differing rates of thermal expansion between the rotor assembly 28 and the inner shell 50. Thermal energy from the heating/cooling system 76 is transferred to the second end 74 of the heat pipe 62 and is released to the inner shell 50.

Varying the heat pipe between heating and cooling modes, as described, allows the clearance between the turbine rotor blades 32, 34 and the turbine rotor shrouds 38, 40 to be maintained during steady-state and transient turbine operation by providing for control of the temperature of the turbine inner shell 50 through the supply of thermal energy by, or removal of thermal energy by, the heating/cooling system 76 which may be external and independent of the turbine 20. In another example, during a negative temperature transient, the inner shell 50 may, for instance, tend to contract more rapidly than the turbine rotor 28 thereby displacing the turbine rotor blade shrouds 38, 40 inwardly towards the tips of the turbine rotor blades 32, 34, respectively. In such a case, thermal energy is supplied to the inner shell 50 by the heat pipes 62 such that the rate of thermal contraction of the inner shell 50 is regulated to a rate that is similar to, or less than, the thermal contraction of the turbine rotor 28 and associated turbine rotor blades 32, 34, avoiding contact between the tips of the turbine rotor blades and the shrouds. During steady state operation, the temperature of the inner shell 50 is controlled, through addition of thermal energy or remove of thermal energy through the heat pipes 72, to maintain a predetermined clearance between the shrouds and the tips of the turbine rotor blades.

While the invention has been described with reference to heat pipes associated with a turbine inner shell, the invention is not to be so limited. It is contemplated that similar application of heat pipes to the turbine housing 30 outer shell or to a gas turbine engine having a single shell is within the scope of the invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gas turbine engine comprising;
a turbine shell configured to retain a turbine rotor shroud adjacent to a turbine rotor blade;
a heat pipe having a first end in thermal communication with the turbine shell and a second end extending outwardly of the shell; and
a heating/cooling system in thermal communication with the second end of the heat pipe and having a thermal medium configurable to exchange thermal energy with the second end of the heat pipe, wherein the heating/cooling system is configurable to remove thermal energy from the second end of the heat pipe to remove thermal energy from the turbine shell and wherein the thermal medium is configurable to add thermal energy to the second end of the heat pipe to add thermal energy to the turbine shell.

2. The turbine engine of claim 1, the heat pipe further comprising;
a casing defining a vacuum sealed inner chamber; and
a heat transfer medium disposed within the vacuum sealed inner chamber of the casing and configured to transfer the thermal energy from the high temperature end of the heat pipe to the low temperature end of the heat pipe for release of the thermal energy to the cooling medium.

3. The turbine engine of claim 2, wherein the heat transfer medium comprises one or more solid layers applied to an interior wall of the casing.

4. A gas turbine engine comprising;
a turbine having a rotor configured for rotation about a shaft;
a turbine rotor blade extending radially outwardly from the rotor to terminate adjacent to a turbine rotor shroud;
a turbine shell configured to retain the turbine rotor shroud adjacent to the turbine rotor blade;
a heat pipe having a first end in thermal communication with the turbine shell and a second end extending outwardly of the shell; and
a heating/cooling system in thermal communication with the second end of the heat pipe and having a thermal medium configurable to exchange thermal energy with the second end of the heat pipe wherein the heating/cooling system is configurable to remove thermal energy from the second end of the heat pipe to thereby remove thermal energy from the turbine shell and wherein the heating/cooling system is configurable to add thermal energy to the second end of the heat pipe to thereby add thermal energy to the turbine shell.

5. The gas turbine engine of claim 4, the heat pipe further comprising;
a casing defining a vacuum sealed inner chamber;
a heat transfer medium disposed within the vacuum sealed inner chamber of the casing and configured to transfer the thermal energy from the high temperature end of the heat pipe to the low temperature end of the heat pipe for release of the thermal energy to the cooling medium.

6. The gas turbine engine of claim 5, wherein the heat transfer medium comprises one or more solid layers applied to an interior wall of the casing.

7. A gas turbine engine comprising;
a turbine having a rotor configured for rotation about a shaft;
a turbine rotor blade extending radially outwardly from the rotor to terminate adjacent to a turbine rotor shroud;
an inner shell configured to retain the turbine rotor shroud adjacent to the turbine rotor blade;
an outer shell configured to support the inner shell;
a heat pipe having a first end in thermal communication with the inner shell and a second end extending outwardly of the shell; and
a heating/cooling system in thermal communication with the second end of the heat pipe and having a thermal medium configurable to exchange thermal energy with the second end of the heat pipe wherein the heating/cooling system is configurable to remove thermal energy from the second end of the heat pipe to thereby remove thermal energy from the inner shell and wherein the heating/cooling system is configurable to add thermal energy to the second end of the heat pipe to thereby add thermal energy to the inner shell.

8. The gas turbine engine of claim 7, the heat pipe further comprising;
a casing defining a vacuum sealed inner chamber;
a heat transfer medium disposed within the vacuum sealed inner chamber of the casing and configured to transfer the thermal energy from the high temperature end of the heat pipe to the low temperature end of the heat pipe for release of the thermal energy to the cooling medium.

9. The turbine engine of claim 8, wherein the heat transfer medium comprises one or more solid layers applied to an interior wall of the casing.
